(19) United States
(12) Patent Application Publication
(10) Pub. No.: US 2006/0227575 A1
(43) Pub. Date: Oct. 12, 2006

(54) Omnidirectional light fixture

(76) Inventors: Adam Powers, Los Angeles, CA (US); John J. Powers, Anchorage, AK (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/101,966

(22) Filed: Apr. 7, 2005

(51) Int. Cl. H01R 33/00

(52) U.S. Cl. 362/650

(57) ABSTRACT

A light fixture is configured such that the fixture can replace a light bulb in a light bulb socket, wherein the fixture further has a continuously adjustable portion to which a secondary light bulb socket is coupled. Most preferably, the adjustable portion is configured as a gooseneck and/or a telescoping element.

### FIELD OF THE INVENTION

The field of the invention is light fixtures.

### BACKGROUND OF THE INVENTION

Numerous light fixtures are known in the art, and depending on the particular needs for illumination, the light fixture may be recessed into a wall or ceiling, disposed on a free standing or wall mounted support, or otherwise coupled to a surface.

For example, recessed light fixtures are often especially attractive or advantageous where light is required over a relatively large area or where inconspicuous light fixtures are desired. While such recessed light fixtures often provide desirable placement, the light direction is typically fixed to a predetermined angle, or only variable among a relatively narrow choice of angles. In other examples, and particularly where a light bulb in a light fixture is supported by a flexible or otherwise adjustable support, power is supplied to the light fixture either via a power cord (e.g., desktop light fixture with gooseneck support), or via attachment to an electric rail or set of electrified wires.

Surprisingly, to the best of the inventor's knowledge, there are no light fixtures with a freely bendable and/or telescoping support that directly replace a light bulb in a light bulb socket, and particularly where the socket is part of a recessed lighting that allows for omnidirectional adjustment of a light bulb in a light fixture while the light fixture is electrically and mechanically coupled to a light bulb socket. Thus, there is still a need to provide improved omnidirectional light fixtures.

### SUMMARY OF THE INVENTION

The present invention is directed to omnidirectional light fixtures that can be inserted into a light bulb socket and bend or otherwise deformed to direct the light of a light bulb that is attached to anther portion of the light fixture to any desired region.

In one aspect of the inventive subject matter, the omnidirectional light fixture has a first portion that is configured to matingly engage with a light bulb socket to thereby make electrical contact. A second portion in contemplated fixtures has a first and a second end, wherein the first end is coupled to the first portion, and wherein the second end is coupled to a third portion, wherein the third portion comprises a secondary light bulb socket that is electrically coupled to the first portion, and wherein the second portion has a deformable element to thereby allow free positioning of the secondary light bulb socket relative to the first portion.

Viewed from another perspective, and especially where the light fixture is sold as a kit, it is contemplated that the kit includes the light fixture contemplated above in combination with an instruction that informs a user to connect the first portion of the light fixture to a light bulb socket of a recessed light fixture housing.

Particularly preferred light bulb sockets to which the light fixture can be connected are mini-candelabra sockets, candelabra sockets, intermediate sockets, medium sockets, mogul sockets, low voltage halogen sockets, and/or halogen socket (each of which are preferably part of a recessed light fixture housing). Therefore, it should be recognized that at least part of the first portion is preferably configured to have a threaded fit with the light bulb socket. Additionally, it is contemplated that the first portion can be detachable from the second portion, which most preferably includes a bendable portion and/or telescoping portion (e.g., goose neck shaft).

The light bulb socket and the secondary light bulb socket in contemplated light fixtures may or may not be the same, and it is further contemplated that at least one of the second and third portions further includes a switch that controls flow of electricity from the light bulb socket to the secondary light bulb socket. or are not the same. With respect to the instructions, it is generally contemplated that the instructions will provide information to connect the first portion of the light fixture to a light bulb socket of a recessed light fixture housing (e.g., by replacing an existing light bulb that is already installed into the light bulb socket). Most typically, such instruction comprises a pictorial and/or verbal representation of the installation process.

Various objects, features, aspects and advantages of the present invention will become more apparent from the following detailed description of preferred embodiments of the invention, along with the accompanying drawing.

### BRIEF DESCRIPTION OF THE DRAWING

FIG. 1 is an exemplary schematic illustration of one light fixture according to the inventive subject matter.

FIG. 2 is an exemplary schematic illustration of another light fixture according to the inventive subject matter.

### DETAILED DESCRIPTION

The inventors have discovered that a light fixture can be manufactured that will provide omnidirectional illumination, extending the scope and/or range of light, while being inserted into a light bulb socket, and particularly into a light bulb socket in the housing of a recessed light fixture.

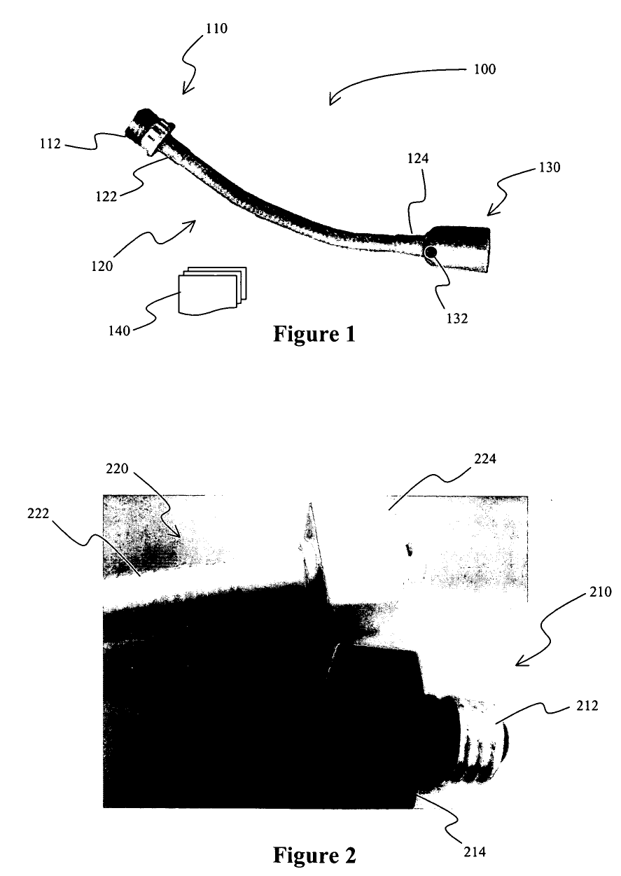

An exemplary light fixture is depicted in FIG. 1, in which omnidirectional light fixture 100 has a first portion 110. Part of the first portion 110 is configured to matingly couple to and electrically connect with a light bulb socket, here depicted as medium socket 112. The first portion 110 is further coupled to a first end 122 of the second portion 120, which is configured as a gooseneck in which electrical wires (not shown) provide electricity from the first portion to the third portion 130, which is coupled to the other end 124 of the second portion 120. At least part of the third portion 130 is configured to receive a light bulb (light bulb socket not shown), and may optionally include one or more additional electrical elements 132, which may be a switch, dimmer, and/or transformer. An instruction 140 may accompany the light fixture as a separate sheet and/or as part of the packaging in which the light fixture is sold.

Where desirable, it should be recognize that the first, second, and/or third portions may be configured as modules, which may be detachably coupled to each other. For example, as depicted in FIG. 2, first portion 210 and second portion 220 are detachably coupled to each other. Here the first portion has a medium size electrical contact portion 212, electrically and mechanically coupled to auxiliary socket 214, which is configured as a female track light contact. Consequently, using the first portion 210 as an adapter, any track light can be electrically and mechanically coupled to a light bulb socket that has a configuration other than a track light (here: medium socket). The second portion 220 is in this example a flexible gooseneck 222 that has on one end a track light contact 224 that delivers electricity to a secondary light bulb socket (not shown) that is electrically and mechanically coupled to another end of the second portion.

Thus, it should be recognized that an omnidirectional light fixture may have one portion that is configured to matingly engage with a light bulb socket to thereby make electrical contact. A second portion in contemplated fixtures has a first and a second end, wherein the first end is coupled to the first portion, and wherein the second end is coupled to a third portion, wherein the third portion comprises a secondary light bulb socket that is electrically coupled to the first portion, and wherein the second portion has a deformable element to thereby allow free positioning of the secondary light bulb socket relative to the first portion. The term “deformable” in conjunction with an element as used herein means that the shape of the element can be manually altered such that the longest dimension of the element can be reduced, and/or that the element can be bent among a plurality of configurations that have a curved portion. In contrast, the term “deformable” as used herein expressly excludes all changes of configuration in the element in which a hinge (e.g., using an axis or ball and socket) enables the deformation.

With respect to the light bulb socket to which part of the first portion can be electrically and/or mechanically coupled, it is generally contemplated that all known light bulb socket types and configurations are suitable for use in conjunction with the teachings herein. However, particularly preferred light bulb sockets include mini-candelabra sockets, candelabra sockets, intermediate sockets, medium sockets, mogul sockets, low voltage halogen sockets, and/or halogen sockets. Thus, and viewed from another perspective, it is generally contemplated that at least part of the first portion is configured to have a threaded fit with the light bulb socket. However, in alternative configurations, pin connector configurations, bayonet configurations, and rail configurations are also deemed suitable. In particularly preferred aspects, however, the light bulb socket is located within, or part of a recessed light fixture housing.

In further contemplated aspects, it should be recognized that the first portion may be configured to be detachable from the second portion. Similarly, it is contemplated that the other portions of contemplated light fixtures may also be detachable from another portion. For example, suitable light fixtures include those in which the second portion is detachable from the third portion. Most preferably, the portions in such light fixtures are configured such that attaching and detaching is performed without use of any tool (e.g., plug-, and/or screw-type attachment). Therefore, it should be recognized that contemplated light fixtures may be configured as modular light fixtures in which different designs and/or configurations for each portion are available.

In further preferred aspects, it is contemplated that the second portion includes at least one deformable portion, which is most typically a bendable portion (e.g., gooseneck shaft) or a telescoping portion. For example, suitable deformable portions can be manufactured from a material that can be manually deformed, and most preferably retains the deformed configuration. Among other suitable materials, flexible polymers, metal reinforced tubular structures, and/or otherwise pliable materials are appropriate. However, and especially where omnidirectional light delivery is not desired, non-deformable and rotatable portions are also contemplated, which may be located in one or more of the first, second, and third portions of contemplated light fixtures.

The third portion in preferred light fixtures typically includes a secondary light bulb socket, and with respect to suitable sizes and configurations, the same considerations as presented above apply. Therefore, depending on the particular configuration, it should be recognized that the light bulb socket (into which the light fixture is mounted) and the secondary light bulb socket may or may not be same. Furthermore, it should be appreciated that the second or third portion may be branched to provide support for another light bulb, which may or may not be the same. Alternatively, the second or third portion may only have an electrical connector to which an additional light fixture or light bulb may be attached.

At least one of the portions, and more typically at least one of the second and third portions may further include an electrical element, and most preferably a switch that controls flow of electricity from the light bulb socket to the secondary light bulb socket. Alternative or additional electric elements include a dimmer, a transformer (e.g., 110 Volt to low voltage, or vice versa, etc.), a timer, etc., each of which may be included into any of the contemplated portions.

It is still further contemplated that the light fixtures presented herein can be sold in pieces (e.g., first, second, and/or third portions separately), or as a complete light fixture. Regardless of the manner of marketing, it is typically preferred that the light fixture (or portion thereof) is associated with an instruction that informs a user to connect the first portion of the light fixture to a light bulb socket, and most preferably to the light bulb socket of a recessed light fixture housing. Therefore, a kit is contemplated having a light fixture having a first portion, a second portion, and a third portion; wherein the first portion is configured to matingly engage with a light bulb socket to thereby make electrical contact; wherein the second portion has a first and a second end, wherein the first end is coupled to the first portion, wherein the second end is coupled to a third portion, and wherein the second portion has a deformable element to thereby allow free positioning of a secondary light bulb socket relative to the first portion; and wherein the third portion comprises the secondary light bulb socket that is electrically coupled to the first portion.

Contemplated kits will preferably include an instruction that informs a user to connect the first portion of the light fixture to a light bulb socket, and most preferably to a light bulb socket of a recessed light fixture housing. It should be recognized that the information may be in written form and/or in pictorial form. Moreover, it is also preferred that the information is associated with the packaging and/or the light fixture. For example, suitable instructions may be in form of a brochure or insert, or be displayed on a web page or TV.

Thus, specific embodiments and applications of omnidirectional light fixtures have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A light fixture, comprising:
a first portion that is configured to matingly engage with a light bulb socket to thereby make electrical contact;
a second portion having a first and a second end, wherein the first end is coupled to the first portion, and wherein the second end is coupled to a third portion;
wherein the third portion comprises a secondary light bulb socket that is electrically coupled to the first portion; and
wherein the second portion has a deformable element to thereby allow free positioning of the secondary light bulb socket relative to the first portion.

2. The light fixture of claim 1 wherein the light bulb socket is selected from the group consisting of a mini-candelabra socket, a candelabra socket, an intermediate socket, a medium socket, a mogul socket, a low voltage halogen socket, and a halogen socket.

3. The light fixture of claim 1 wherein at least part of the first portion is configured to have a threaded fit with the light bulb socket.

4. The light fixture of claim 1 wherein the first portion is configured to be detachable from the second portion.

5. The light fixture of claim 1 wherein the light bulb socket is part of a recessed light fixture housing.

6. The light fixture of claim 1 wherein the second portion includes at least one of a bendable portion and a telescoping portion.

7. The light fixture of claim 6 wherein the bendable portion comprises a gooseneck shaft.

8. The light fixture of claim 1 wherein the light bulb socket and the secondary light bulb socket are not the same.

9. The light fixture of claim 1 wherein at least one of the second and third portions further includes a switch that controls flow of electricity from the light bulb socket to the secondary light bulb socket.

10. The light fixture of claim 1 further comprising an instruction associated with the light fixture, wherein the instruction informs a user to connect the first portion of the light fixture to a light bulb socket of a recessed light fixture housing.

11. A kit comprising:
a light fixture having a first portion, a second portion, and a third portion;
wherein the first portion is configured to matingly engage with a light bulb socket to thereby make electrical contact;
wherein the second portion has a first and a second end, wherein the first end is coupled to the first portion, wherein the second end is coupled to a third portion, and wherein the second portion has a deformable element to thereby allow free positioning of a secondary light bulb socket relative to the first portion;
wherein the third portion comprises the secondary light bulb socket that is electrically coupled to the first portion; and
an instruction that informs a user to connect the first portion of the light fixture to a light bulb socket of a recessed light fixture housing.

12. The light fixture of claim 11 wherein the light bulb socket is selected from the group consisting of a mini-candelabra socket, a candelabra socket, an intermediate socket, a medium socket, a mogul socket, a low voltage halogen socket, and a halogen socket.

13. The light fixture of claim 11 wherein at least part of the first portion is configured to have a threaded fit with the light bulb socket.

14. The light fixture of claim 11 wherein the first portion is configured to be detachable from the second portion.

15. The light fixture of claim 11 wherein the light bulb socket is part of a recessed light fixture housing.

16. The light fixture of claim 11 wherein the second portion includes at least one of a bendable portion and a telescoping portion.

17. The light fixture of claim 16 wherein the bendable portion comprises a goose neck shaft.

18. The light fixture of claim 11 wherein the light bulb socket and the secondary light bulb socket are not the same.

19. The light fixture of claim 11 wherein at least one of the second and third portions further includes a switch that controls flow of electricity from the light bulb socket to the secondary light bulb socket.

20. The light fixture of claim 11 further comprising a transformer coupled to the light fixture and electrically coupled such that the transformer changes voltage of the light bulb socket relative to the secondary light bulb socket.
